(19) United States
(12) Patent Application Publication
(10) Pub. No.: US 2011/0279452 A1
(43) Pub. Date: Nov. 17, 2011

(54) MAP DISPLAY APPARATUS

(75) Inventors: Hiromi IBE, Obu-city (JP); Rieko Arai, Nagoya-city (JP)

(73) Assignee: DENSO CORPORATION, Kariya-city (JP)

(21) Appl. No.: 13/101,503

(22) Filed: May 5, 2011

(30) Foreign Application Priority Data
May 13, 2010 (JP) 2010-111415
Apr. 11, 2011 (JP) 2011-87652

(51) Int. Cl. G06T 15/00

(52) U.S. Cl. 345/419

(57) ABSTRACT

A map display apparatus is disclosed, which includes a display for display of a 3D map on a map display screen and a controller for displaying the 3D map in first or second 3D state, and switches a display state of the 3D map from the first 3D state to the second 3D state in response to satisfaction of a predetermined switching condition in the first 3D state. In the first 3D state, a road is drawn in an upper/lower direction of the map display screen and front view object images, each being is an image of an object facing onto the road and viewed from the road, are arranged facing onto the road. In the second 3D state, at least some of the front view object images are rotated more toward position of being perpendicular to a line of sight e than in the first 3D state.

### CROSS REFERENCE TO RELATED APPLICATION

The present application is based on and claims priority to Japanese Patent Applications No. 2010-111415 filed on May 13, 2010 and No. 2011-87652 filed on Apr. 11, 2011, disclosures of which are incorporated herein by reference.

### TECHNICAL FIELD

The present invention relates to a map display apparatus. In particular, the present invention relates to a map display apparatus capable of displaying a 3D (three-dimensional) map.

### BACKGROUND

Various display apparatuses capable of displaying a 3D map are known. For example, many navigation apparatuses function as this map display apparatus.

In a typical 3D map, buildings are arranged in the same way as actual buildings are located. In a 3D map, a front view building image (i.e., an image of a building viewed from a road side) is drawn so as to face onto a road.

In a known technique (JP-2007-4293A1 for example), a target object viewed in an oblique direction with respect to the target object is converted into an image of the target object viewed in a front direction. A 3D map can be produced using, for example, the technique described in JP-2007-4293A1.

As described above, in a conventional 3D map, a front view building image is drawn so as to face onto a road. A 3D map as a whole is drawn from a viewpoint that is set in consideration of eye position of a user (e.g., a driver) or a viewpoint (e.g., bird's view) that is located close to the user. Further, a 3D map is drawn in perspective. In perspective, a viewpoint is set, and a projection plane is set between a drawing target and the viewpoint. The drawing target projected onto the projection plane becomes a drawing produced in perspective. Since the projection plane is set parallel to the drawing target, a height direction is represented as an upper/lower direction of the 3D map.

When a line of sight is set to a direction extending from the viewpoint perpendicularly to the projection plane, a center of the projection plane is a point where the line of sight intersects with the projection plane. When this line of sight and a longitudinal direction of a road coincide with each other in a left/right direction, the road is drawn in the upper/lower direction in the 3D map.

For example, when the line of sight extends along a road, the longitudinal direction of the road and the line of sight coincide with each other in a left/right direction, and thus, the road is vertically drawn in an upper/lower direction. A normal line of a surface, facing onto the road, of a building on a road side (i.e., a surface on which a front view building image appears) does not coincide with a line-of-sight direction. That is, the normal line is inclined with respect to the line of sight, and the front view building image is arranged inclined with respect to the line of sight.

When the front view building image is displayed while being inclined with respect to the line of sight, it becomes difficult to grasp the front view building image in detail. As the inclination of the front view building image with respect to the line of sight is larger, it becomes more difficult to grasp the front view image building in detail. In particular, since a front view building image of a building located distant from the viewpoint is displayed in small size in a 3D map, a large inclination with respect to the line of sight makes it particularly difficult to recognize the front view building image within a short time. Depending on cases, a front view building image cannot be correctly recognize until the viewpoint moves to the vicinity of a front face of the front view building image.

In actual scenery, front faces of buildings are often visible, and further, impressions of the front faces of buildings are memorable. Thus, when the front view building image is displayed while being inclined with respect to the line of sight in a manner like a conventional manner, a problem is that it is difficult for a person to check a building displayed in a 3D map against a building in his or her memory or a building that the person is actually seeing.

### SUMMARY OF THE INVENTION

The present invention is made in view of the foregoing, and has an objective to provide a map display apparatus that can make it easier to check a building displayed in a 3D map against a building in his or her memory or building that a person is actually seeing.

According to an aspect of the present invention, a map display apparatus configured in the following way is provided. The map display apparatus includes: a display device that displays a 3D map on a map display screen; and a controller that causes the display device to display the 3D map in a first 3D map display state or a second 3D map display state, and switches a display state of the 3D map from the first 3D map display state to the second 3D map display state in response to satisfaction of a predetermined switching condition in the first 3D map display state. In the first 3D map display state, a road is drawn in an upper/lower direction of the map display screen and front view object images, each of which is an image of an object facing onto the road and viewed from the road, are arranged facing onto the road. In the second 3D map display state, at least some of the front view object images is rotated more toward position of being perpendicular to a line of sight than in the first 3D map display state.

According to the above map display apparatus, in response to the satisfaction of the predetermined switching condition, the front view object images are switched from the first 3D map display state, in which the front view object images are arranged facing onto the road drawn in the upper/lower direction of the map display screen and the front view object images are accordingly inclined with respect to the line of sight, to the second 3D map display state, in which at least some of the front view object images are rotated more toward the position of being perpendicular to the line of sight than in the first 3D map display state. Therefore, the front view object images of individual objects becomes easily conformable as compared with a conventional 3D map in which front view object images are arranged always facing onto a road. In actual scenery, front faces of objects are often visible, and further, impressions of the front faces of objects are often memorable. Thus, when the front view object images of individual objects are easily confirmable, the objects displayed on the map display screen can be easily checked against objects in his or her memory or objects that a person is actually seeing.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram illustrating a mechanical configuration of an in-vehicle navigation apparatus functioning as a map display apparatus;

FIG. 2 is a diagram showing one example of a first 3D map display state;

FIG. 3 is a diagram illustrating a state where a front view building image is viewed from the front;

FIG. 4 is a diagram showing one example of the second 3D map display state;

FIG. 5 is a diagram illustrating first motion of a front view building image in the second 3D map display state;

FIGS. 6A to 6C are diagrams illustrating actual initial motion in the second 3D map display state;

FIG. 7 is a diagram illustrating suppression of rotation and displacement of a front view building image located in front of an intersection;

FIG. 8 is a diagram illustrating a display manner for facilitating confirmation of a front view building image that faces onto a road intersecting with a traveling road;

FIG. 9 is a diagram conceptually illustrating an image movement operation shown in FIG. 8;

FIG. 10 is a flowchart illustrating a process that a navi. ECU performs in conducting map drawing processes to display a 3D map in a second 3D map display state;

FIG. 11 is a diagram illustrating front view building images in a vertical direction and a horizontal direction; and

FIG. 12 is a diagram showing one example in which copies of front view building images are displayed in association with the original front view building images in order, with movement of present position.

### EMBODIMENTS

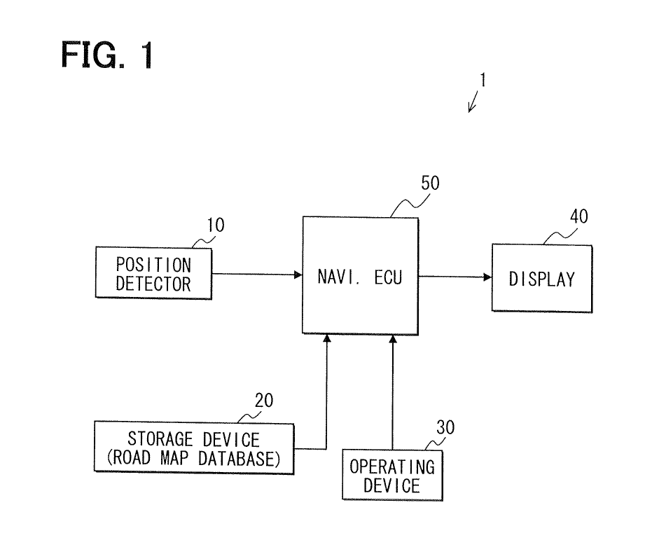

Embodiments will be described below with reference to the drawings. The below-described embodiment is an in-vehicle navigation apparatus 1 having a function of a map display apparatus. FIG. 1 is a block diagram illustrating a mechanical configuration of the navigation apparatus 1.

As shown in FIG. 1, the navigation apparatus 1 includes a position detection device 10, a storage device 20, an operating device 30, a display device 40, and a navi. ECU 50.

The position detection device 10 successively detects present position of a vehicle. The position detection device 10 includes known sensors for locating, such as a GPS receiver for radio navigation, an acceleration sensor for autonomous navigation, a gyro sensor, a vehicle speed sensor and the like. Based on signals of these sensors etc., the position detection device 10 successively detects the present position of the vehicle.

The storage device 20 stores a map database. The map database includes an image data needed to display a 3D map, in addition to a data indicating road shapes and a data indicating building positions.

The operating device 30 is manipulatable by a user. A user can give instructions to the navigation apparatus 1 via the operating device 30. The operating device 30 is located at a place that enables a driver sitting down in a driver seat to manipulate the operating device 30.

The display device 40 includes, for example, a liquid crystal display, and has a map display screen on which a 3D map can be displayed. The display device 40 is located at a place, e.g., a center console etc., that enables the driver to visually recognize the display screen.

The navi. ECU 50 (Electronic Control Unit) includes a computer with a CPU (Central Processing Unit), ROM (Read-Only Memory), RAM (Random Access Memory) and the like. The CPU executes a program stored in the ROM while using a temporal storage function of the RAM, thereby controlling the position detection device 10, the storage device 20 and the display device 40. By controlling these devices, the CPU achieves various functions such as a map drawing function, a destination setting function, a route retrieval function, a route guidance function and the like. The various functions include functions that a typical navigation apparatus has. The navi. ECU 50 can function as a controller.

The above map drawing function allows display of a 3D map. A display state of the 3D map includes two display states, a first 3D map display state and a second 3D map display state. It should be noted that the map drawing function can put the map display screen as a whole in the first or second 3D map display state. Further, the map drawing function can put a portion of the map display screen in the first 3D map display state and the remaining portion of the map display screen in the second 3D map display state.

In the first 3D map display state, a road on which the vehicle equipped with the navigation apparatus 1 is presently traveling (also referred to hereinafter as “a traveling road”) is drawn in an upper/lower direction of the map display screen. A front view building image, which is an image of a building that faces onto the road and that is viewed from the road, is arranged in the 3D map so as to face onto the road. In the second 3D map display state, the traveling road is drawn in the upper/lower direction of the map display screen like that in the first 3D map display state is drawn. However, In the second 3D map display state, at least some of front view building images are rotated more toward position of being perpendicular to a line of sight than in the first 3D map display state. It should be noted that a viewpoint for map drawing in the first 3D map display state and a viewpoint for map drawing in the second 3D map display state are the same and are determined based on the vehicle position. Therefore, the viewpoint for map drawing moves as the vehicle position moves. It should be noted that the line of sight originates from this viewpoint, and corresponds to a movement direction of the vehicle position.

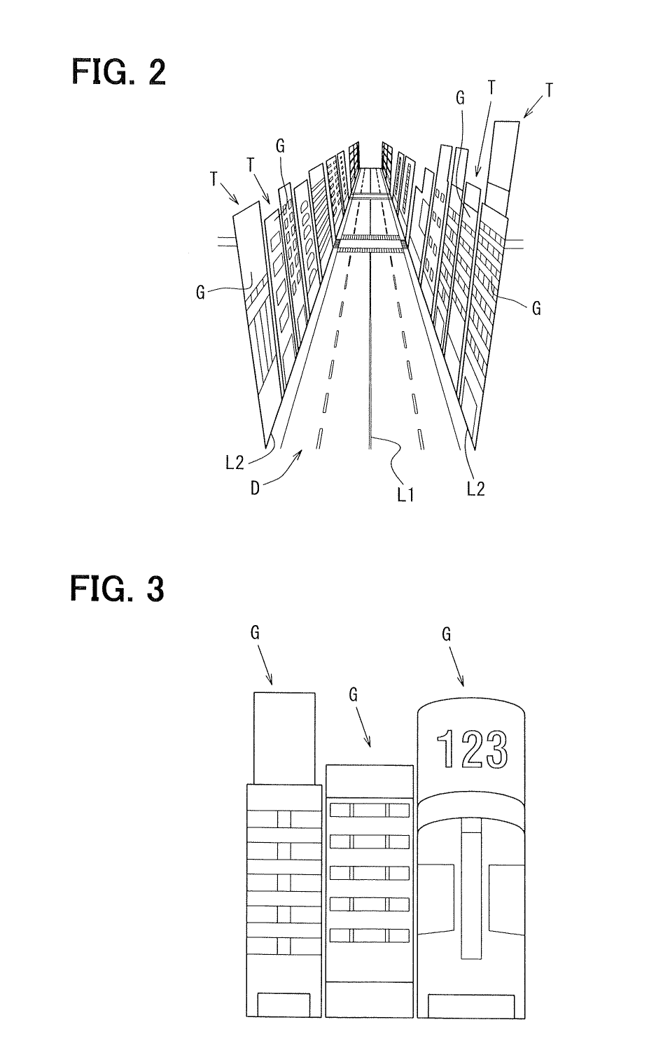

FIG. 2 is a diagram showing one example of the first 3D map display state.

As shown in FIG. 2, in the first 3D map display state, multiple front view building images G are arranged facing onto a road image D. As shown in FIG. 2, every front view building image G appears on a road side surface (i.e., a surface facing onto the road image D) of a building graphic T shown as a flat plate. In FIG. 2, reference symbols T, G are assigned to only some of the building graphics and the front view building images.

As can be seen from FIG. 2, in the first 3D map display state, the 3D map is drawn in perspective. The second 3D map display state is the same in that the map is drawn in perspective.

In a drawing produced in perspective, an area closer to a viewpoint is drawn at a lower portion of a map and an area distant from the viewpoint is drawn at an upper portion of the map. When a vanishing point exists in the map, an object distant from the viewpoint is drawn at a place closer to the vanishing point. Further, in a perspective drawing, an object is drawn in smaller size as the object is distant from the viewpoint. Thus, a road drawn in the upper/lower direction has, on the map, a wider width at the lower portion of the map and a smaller width at the upper portion of the map even when actual width of the road is constant with a longitudinal direction.

The first 3D map display state in FIG. 2 will be more specifically described. The viewpoint for map drawing is set just above the vehicle that is traveling on the road. The road image D has a width direction center line L1 (shown as a road centerline in FIG. 2), which straightly extends in the upper/lower direction on the map, indicating that this road is straight.

Although FIG. 2 does not show the whole screen shape for displaying the 3D map, the screen shape is rectangular, and a width direction center line L1 is perpendicular to a lower side and an upper side of the screen. The road image D has a larger road width at a lower portion of the map (i.e., at a portion closer to the viewpoint for drawing). In other words, the road width is smaller at an upper portion of the map. At the upper portion of the map, a pair of edge lines L2 of the road image D has a smaller distance to the width direction centerline L1 in a lateral direction

The building graphic T is drawn so that the building graphic T is in an upright position relative to the road image D. That is, a side of the building graphic T, the side extending in a vertical direction in reality, is drawn so as to extend in a generally upper/lower direction on the map, and a lower side of the building graphic T has an angle along the edge line L2 of the road image D. Since the building graphic T is arranged in the above way, the front view building image G appearing on the building graphic T faces onto the road image D in the first 3D map display state. To put facing onto in another way, a whole of the lower side of the front view building image G is in contact with the road image D in the same manner as an actual building corresponding to the front view building image G is.

As is clear from FIG. 2, since the edge line L2 of the road image D is not horizontal, the lower side of the front view building image G along the end line D2 is also not horizontal. Accordingly, a normal line of the front view building image G is not perpendicular to the projection plane. Thus, when a direction extending perpendicularly to the projection plane from the viewpoint is considered to be the line of sight, the line of sight and the normal line of the front view building image are not parallel to each other and are inclined with each other.

While the lower side of the front view building image G is not horizontal, another side corresponding to a vertical direction side of the actual building extends also generally in the upper/lower direction on the map. In the first 3D map display state, the front view building image G is displayed such that even when the lower side and the vertical direction side of the actual building have right angles therebetween, the lower side and the vertical direction side of the front view building image G showing the building have an angle deviated from the right angle. This causes a discrepancy between the front view building image G and a actual building viewed from its front side.

As described above, the front view building image G is an image of a building that faces onto a road and that is viewed from the road. FIG. 3 illustrates a state of the front view image G viewed from the front. As shown in FIG. 3, a gap is provided between the front view building images G adjacent to each other. This facilitates recognition of an individual front view building image G in distinction from an adjacent front view building image G. When the front view building images G are arranged along the road image D like those in FIG. 2, it is difficult to see the gap compared with FIG. 3, although the gap is perceivable. In FIG. 2 also, the gap facilitates the recognition of an individual front view building image G in distinction from an adjacent front view building image G.

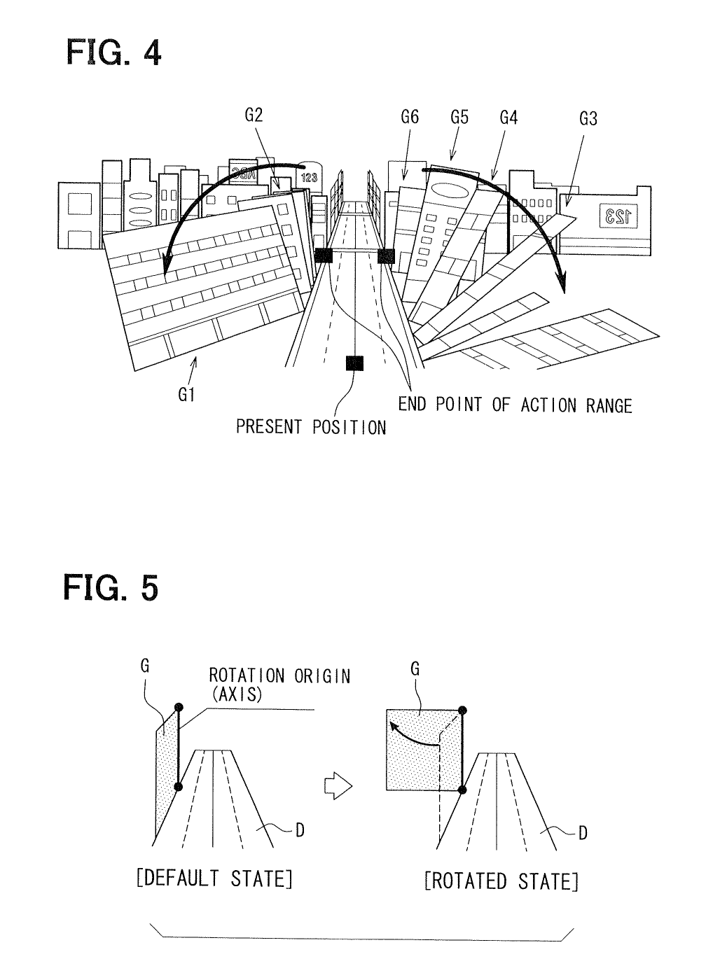

FIG. 4 is a diagram showing one example of the second 3D map display state. As shown in FIG. 4, in the second 3D map display state, front view building images G belonging to a predetermined action range are rotated more toward the position of being perpendicular to the line of sight than in the first 3D map display state illustrated in FIG. 2. In the above, the action range is set to such a range that usually allows the driver to check buildings on the map against the buildings in his or her memory or the buildings the driver is actually seeing. For example, the action range is set to have a predetermined distance from the vehicle in a heading direction of the vehicle. Alternatively, the action range may not set on a distance-basis. The action range may be set to a range from the vehicle to a predetermined reference point, e.g., a range from the vehicle position to a next intersection. Alternatively, the action range may be set to a range that causes a number of front view building images G to be a predetermined number.

In the second 3D map display state, images other than an image of the traveling road, an image of another road intersecting with the traveling road at a next intersection, and the building graphics showing buildings facing onto the above roads are display in single color (e.g., white). Thus, portions separated from the roads by the buildings facing onto the roads are displayed in single color. In the first 3D map display state also, portions separated from the roads by the buildings facing onto the roads are displayed in single color as is the case in the second 3D map display state. Because of this, the front view building images G are well viewable, and thus, from the front view building images G, it becomes easy to understand shape and height etc. of building fronts.

In the second 3D map display state, a state (display state) of the front view building image G is changed with movement of the vehicle position. As described above, the viewpoint for map drawing is determined based on the vehicle position. Definitely, the vehicle travels on the road. The viewpoint for map drawing accordingly moves along the road on which the vehicle is traveling. The second 3D map display state is switched from the first 3D map display state. In the following, explanation will be given on switching from the first 3D map display state to the second 3D map display state, and changing the state (display state) of the front view building image G in the second 3D map display state.

As described above, in the first 3D map display state, the front view building images G are arranged facing onto the road. When a predetermined switching condition is satisfied in the first 3D map display state, the switching into the second 3D map display state occurs.

For example, the satisfaction of the switching condition is achieved by passing through (including going straight, turning right and turning left) an intersection, or a predetermined switching operation by a user, or the like. In response to switching into the second 3D map display state upon the satisfaction of the switching condition, the front view building images G belonging to the above-described action range are rotated together until the front view building images G are positioned perpendicular to the line of sight.

FIG. 5 is a diagram illustrating the first motion of the front view building image G in the second 3D map display state. In FIG. 5, a default state corresponds to a time at which the switching condition is satisfied, that is, the default state is the first 3D map display state. In this default state, the front view building images G are arranged facing onto the road image D.

In the second 3D map display state, first, beginning with the default state, the front view building image G is rotated around a rotation origin (axis) to the position of being perpendicular to the line of sight. This rotation operation is performed on all of the front view building images G belonging to the above-described action range at the same time. The rotation axis is a vertical axis passing through a far end point of the lower side of the front view building image G. That is, the rotation axis is an axis passing one of a right side and a left side of the front view building image G, the one being distant from the view point than the other of the right side and the left side. A rotation direction is a direction away from the other, which is not the rotation axis, of the right side and the left side of the front view building image G.

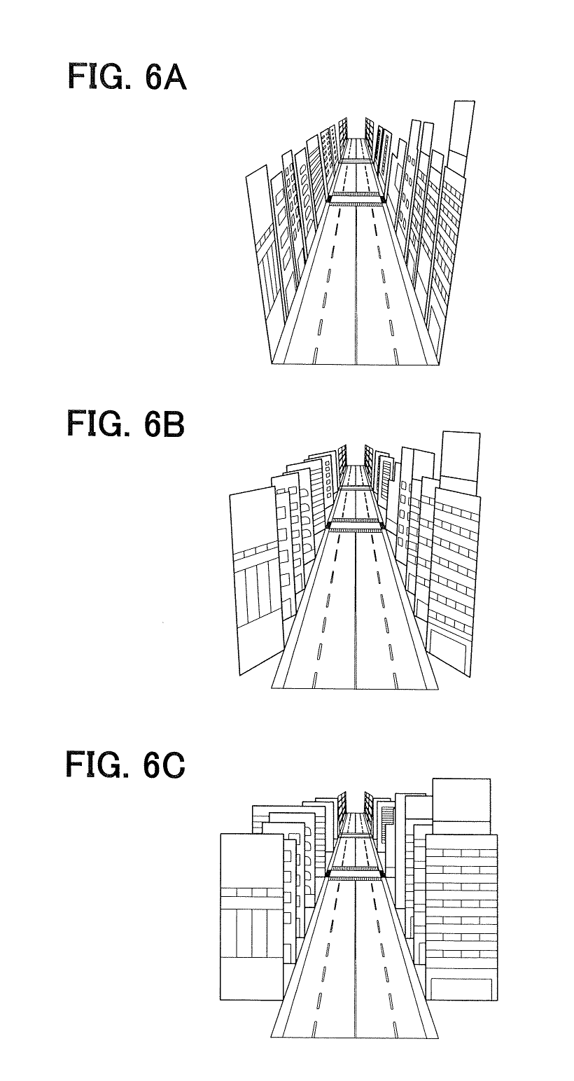

FIGS. 6A to 6C are diagrams illustrating actual initial motion in the second 3D map display state. FIG. 6A is a diagram corresponding to the default state in FIG. 5. Beginning with the state in FIG. 6A, multiple front view building images G contained in the action range are rotated around the rotation axis, and the multiple front view building images G are positioned perpendicular to the line of sight, and a resultant state is shown in FIG. 6C. As shown in FIG. 6C, the position where the lower side of the front view building image G extends in the horizontal direction is the position where the front view building image G is perpendicular to the line of sight. In FIG. 6B, the front view building image G is in the course of rotation.

As shown in FIG. 6C, when all of the front view building images G belonging to the action range have become perpendicular to the line of sight, the CPU performs a sequential move operation for sequentially moving the front view building images G. In the sequential move operation, with the movement of the viewpoint, two rotation displacement operations are simultaneously performed on each of the front view building images G. The two rotation displacement operations are a first rotation displacement operation and a second rotation displacement operation. As described above, it should be noted that, as he vehicle position moves, the viewpoint moves accordingly.

The first rotation displacement operation is an inverted rotation displacement operation illustrated in FIG. 5. The first rotation displacement operation rotates and displaces the front view building image G around the rotation axis of FIG. 5 until a whole of the lower side of the front view building image G contacts the road onto which the front view building image G in the default state faces. The second rotation displacement operation uses the lower side of the front view building image G as the rotation axis and makes the front view building image G fall down in such a direction that the upper side of the front view building image G moves in a direction to an outside of the road.

The CPU starts performing the first rotation displacement operation and the second rotation displacement operation on a front view building image G when distance from the viewpoint or the vehicle position to the front view building image G becomes less than or equal to a predetermined distance. Thus, as the viewpoint moves, the CPU sequentially starts performing the operations on the front view building images G that were located distant at the beginning. Then, after the start of the operations, the rotation operation proceeds in accordance with the vehicle position after the start of the operations. Accordingly, as the movement of the vehicle, the front view building images G fall down in order of increasing distance from the vehicle position, such that the upper side of the front view building image G falls toward the outside of the road while the whole of the lower side is approaching a state of contacting with the road. Because of the above operations, as shown in FIG. 4, the front view building images G within the action range fall down to a larger extent as the front view building image G is closer to the vehicle, and the lower side of the near side front view building image is closer to a state of being parallel to the road side surface

When the near side one falls down to a larger extent in the above way, the front view building images G displayed closer to the viewpoint in a movement direction of the viewpoint for map drawing become less overlapped with other front view building images G displayed distant from the viewpoint in the movement direction of the viewpoint for map drawing, as compared with a state (see FIG. 6) where all of the front view building images G are confronted. Because of this, a user can check in turn the multiple front view building images G drawn in the heading direction, with the front view building images G being less overlapped.

A final position of the front view building image G by the first and second rotation displacement operations is not shown in FIG. 4. The final position of the front view building image G by the first and second rotation displacement operations is a position where the front view building image G becomes finally parallel to the road side surface and the whole lower side contacts the road image D. The first and second rotation displacement operation are continuously performed on the front view building image G until the front view building image G is in the final position.

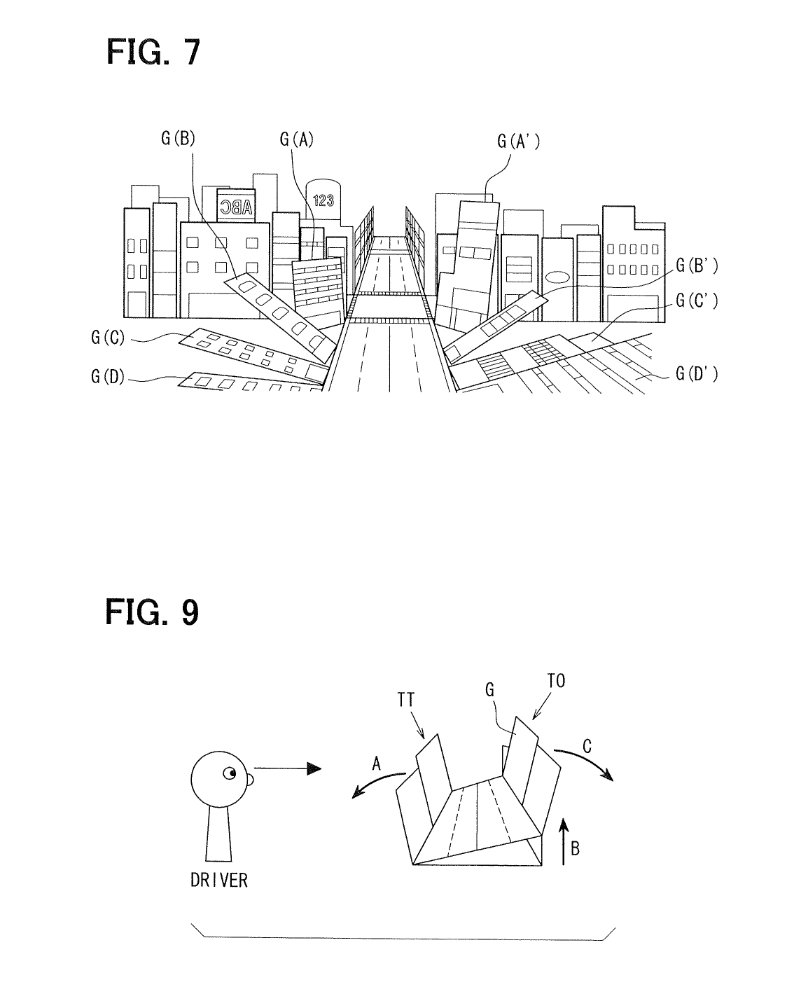

In the present embodiment, a mark building is set to a building that is one or ones of multiple buildings located at corners of an intersection and that is located before the intersection (located closer to the vehicle equipped with the navigation apparatus 1 than the others of the multiple buildings). In FIG. 7, the front view building image of the above building is G(A) and G(A′). The first and second rotation displacement operations on the front view building images G(A), G(A′) are temporality suspended or delayed until the viewpoint, which is set just above the vehicle position, passes through the front view building images G(A) and G(A′). Thereby, the rotation and displacement of the front view building images G(A) and G(A′) are suppressed.

In FIG. 7, since the viewpoint has not passed through the front view building images G(A) and G(A′) yet, the first and second rotation displacement operations are suppressed. Thus, a difference in rotation displacement degree between the front view building images G(A) and G(A′) and adjacent front view building images G(B) and G(B′) is larger than a different between G(B) and G(C), a difference between G(C) and G(D), a difference between G(B′) and G(C′) and a difference between G(C′) and G(D′). Although not shown in the drawings, in the present embodiment, rotation position of the front view building image G(A), G(A′) is kept at the position illustrated in FIG. 7 until the viewpoint passes through the front view building image G(A), G(A′).

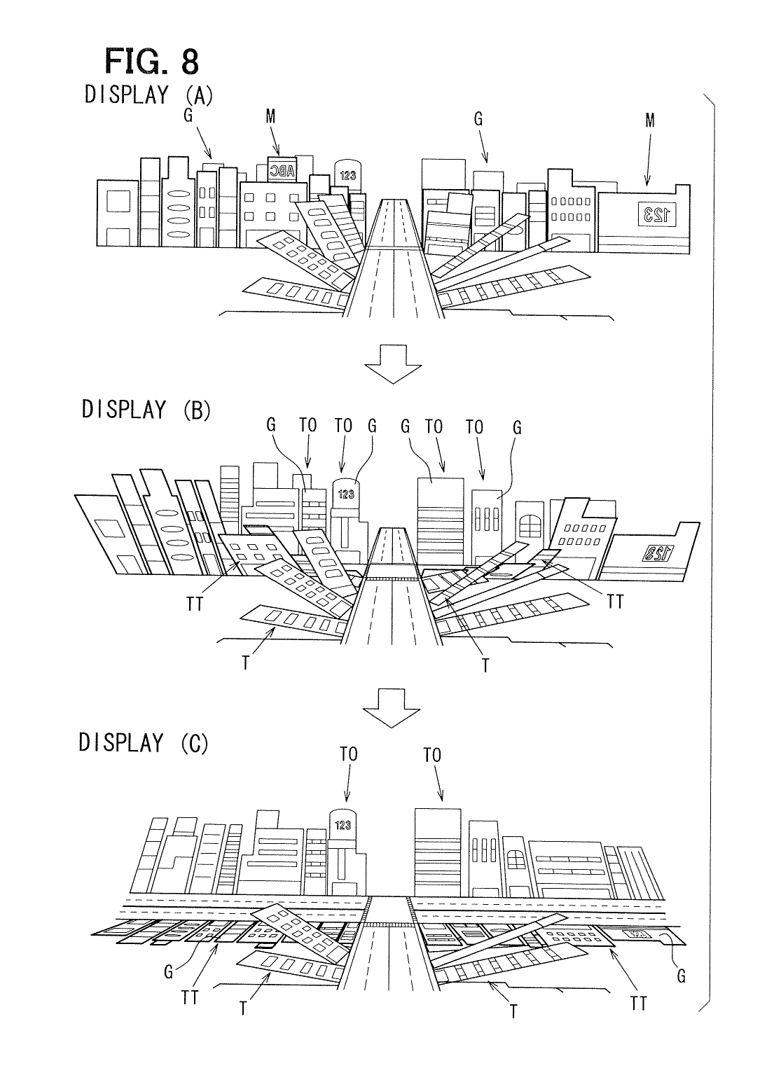

The present embodiment has three artifices (display manners) to facilitate checking a front view building image G that faces a road (i.e., a road intersecting with the movement direction of the viewpoint, which is also referred to hereinafter as an intersecting road) intersecting with the road on which the vehicle is traveling. In the following, the three artifices will be explained with FIG. 8.

(First Artifice)

In real scenery, a user cannot see a front face of a building (also referred to hereinafter as an intersecting road near side building) that is one or ones of building facing onto the intersecting road and that is located on a vehicle side of the intersecting road. If it is assumed that there is no shielding object between the vehicle and the building on the near side of the intersecting road, only a back of the building (opposite to the surface facing onto the road) is visible. In the present embodiment, the display device 40 displays a building mirror image M on a back of the building graphic (an opposite surface, which is opposite to a surface on which the front view building image G appears. The building mirror image M is a mirror image of the front view building image G. A display manner (A) in FIG. 8 illustrates an example of the building mirror image M. Because of the mirror images, letters “123”, “ABC” on the building mirror images M are mirror-reversed. Since the mirror images are displayed in this way, this makes a building front view confirmable while avoiding a false impression that the building mirror images M are located on a far side of the intersecting road. It should be noted that in FIG. 8, only some of the building mirror images have the reference symbol M.

(Second Artifice)

As shown in the display manner (A) in FIG. 8, the building on the near side of the intersecting road hides a building (i.e., a building on a far side of the intersecting road) that is one or ones of the buildings facing onto the intersecting road and that is located distant form the vehicle than the other of the buildings, although the front face of the building on the far side of the intersecting road faces the vehicle. In the display manner (A) in FIG. 8, it is difficult to check the front view building images G of the buildings on the far side of the intersecting road.

However, in th present embodiment, when a user gives instructions for far side building check to the navigation apparatus 1 via a switch or his or her speech, a preset condition is satisfied, and the 3D map display is changed from the display manner (A) to the display manner (C) via the display manner (B).

As shown in the display manner (B) of FIG. 8, in response to the instructions for far side building check, the building graphics TT on the near side of the intersecting is rotated and displaced with the lower side acting as the rotation axis, so that the upper side moves toward an outside of the road. That is, the building graphic TT on the near side of the intersecting road falls toward the near side by using the lower side as the rotation side. An arrow A in FIG. 9 conceptually illustrates this rotation displacement. Because of the rotation displacement indicated by the arrow A, the building graphic TO on the far side of the intersecting road is not hidden by the building graphic TT on the near side of the intersecting road any more. Thus, it becomes easier to check the front view building image G of the building graphic TO on the far side of the intersecting road. This is the second artifice.

The building graphics TT on the near side of the intersecting road start rotating in order of increasing distance from the intersection, and eventually, the building graphics TT becomes parallel to the road side surface of the traveling road, as shown in the display manner (C) of FIG. 8. When the building graphics TT on the near side of the intersecting road has rotated to the above position, it becomes easier to check the front view building images G appearing on a road plane of the building graphics TT. When the building graphic TT on the near side of the intersecting road falls toward the near side, and when the building graphic T, which shows a building facing onto the traveling road, falls in a direction away from the road with the upper side of the building graphic T acting as the rotation axis, these building graphics T and TT are overlapped in the vicinity of the intersection. However, in the present embodiment, while the building TT on the near side of the intersecting road is put above, the building graphic T facing onto the traveling road is also displayed. Alternatively, when the building graphic TT on the near side of the intersecting road and the building graphic T facing onto the traveling road are overlapped, one of the building graphics T and the building graphics TT are lightly displayed or are not drawn to improve viewability of the other of the building graphics T and TT.

(Third Artifice)

As described above, when the instructions for far side building check is given to the navigation apparatus 1, the building graphic TT on the near side of the intersecting road is rotated, and in addition, the building graphic TO on the far side of the intersecting road is displaced upward in the screen and rotated around the rotation axis, which is the lower side, toward the far side (direction in which the upper side moves toward the outside of the intersecting road) as shown in the display manner (B) and the display manner (C) of FIG. 8. Furthermore, as the building graphic TO on the far side of the intersecting road is displaced upward, a far side portion of the intersecting road, onto which the building graphic TO faces, is displaced upward so that the intersecting road is inclined. Arrows B and C conceptually indicate the above displacements. The displacement indicated by the arrows B, C can further improve the viewability of the front view building image G appearing on the building graphic TO on the far side of the intersecting road.

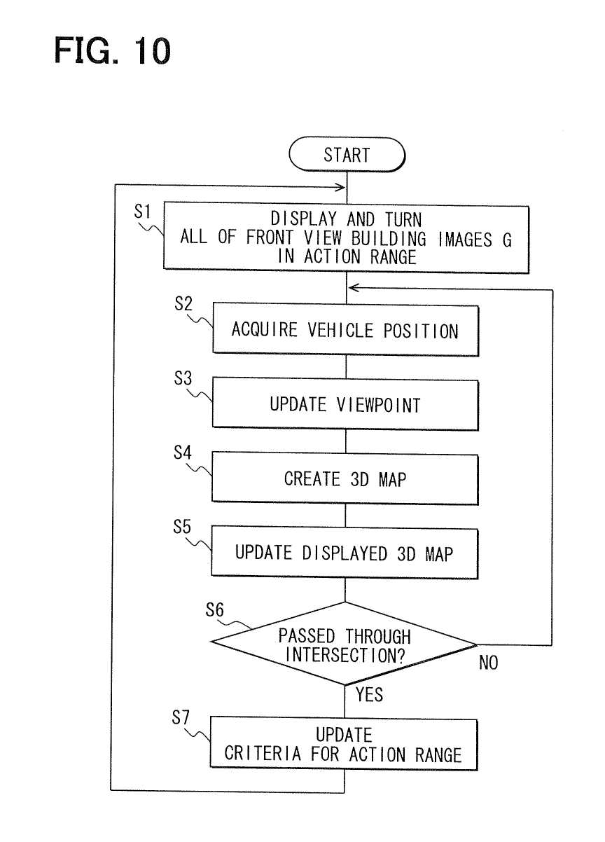

FIG. 10 is a flowchart illustrating a process that the navi. ECU 50 of the present embodiment performs in conducting the map drawing processes to display the 3D map with the second 3D map display state. In response to the satisfaction of the predetermined condition in the first 3D map display state, the process illustrated in this flowchart is performed. It should be noted that the following explanation is based on assumption that the action range is from the vehicle position to a next intersection.

At step S1, the navi. ECU 50 rotates all of the front view building images G within the action range by setting the rotation axis to a vertical axis passing through a far side end point of the lower side of the front view building image G, so that the front view building images G is in the position of being perpendicular to the line of sight. At step S2, the navi. ECU 50 acquires the present position of the vehicle from the position detection device 10. At S3, the navi. ECU 50 updates the position of the viewpoint based on the present position acquired at step S2.

At step S4, the navi. ECU 50 generates the 3D map. In this step S4, from the storage device 20, the navi. ECU 50 acquires a data for a range determined based on the viewpoint updated at step S30. Then, based on the acquired data, the navi. ECU 50 generates the 3D map containing the road image D, the front view building image G and the like. In generating, the navi. ECU 50 performs the above-described first displacement rotation operation and the above-described second displacement rotation operation on the front view building images G facing onto the vehicle traveling road, according to the distance from the viewpoint. In the second displacement rotation operation, the rotation and displacement of the front view building image G of the marked building is suppressed as compared with other front view building images G. In the above, the marked building is one or ones of the buildings located at corners of the first intersection in front on the traveling road, the one or ones being located on the near side of the intersection. Moreover, regarding the buildings facing onto the intersecting road and located on the vehicle side of the intersecting road, the building mirror images M is shown on vehicle side surfaces of the buildings.

At subsequent step S5, the navi. ECU 50 updates the displayed 3D map by displaying the 3D map generated at step S4 in place of the 3D map displayed so for on the display device 40. At subsequent step S6, the navi. ECU 50 determines whether the present position of the vehicle has passed through the intersection. This determination results in YES at a time when it is determined the position of the vehicle has come out of the intersection after the position of the vehicle was within the intersection. When this determination results in NO, the process returns to step S2. When this determination results in YES, the process proceeds to step S7.

At step S7, the navi. ECU 50 updates the intersection acting as the basis for the action range to another intersection that has now becomes a next intersection. The navi. ECU 50 sets the action range to a range from the vehicle position to the next intersection. Then, the process returns to step S1. Through the above way, after passage through the intersection, the front view building images G facing onto the vehicle traveling road and located from the vehicle position to the next intersection are simultaneously put in position where the front view building images G are perpendicular to the line of sight. After that, as the vehicle moves (i.e., with the movement of the line of sight), the front view building images G facing onto the vehicle traveling road are sequentially rotated and displaced by the above-described first rotation displacement operation and the above-described second rotation displacement operation.

According to the above-described present embodiment, since the switching from the first 3D map display state to the second 3D map display state can occur, the front view building images G of individual buildings can be easily conformable as compared to a conventional 3D map in which front view building images are arranged always facing onto a road. In actual scenery, front faces of buildings are often visible, and further, impressions of the front faces of buildings are often memorable. Thus, since the front view building images G of individual buildings are easily confirmable in the present embodiment, a front view building image G displayed on the map display screen can be easily checked against a building in his or her memory or a building that a person is actually seeing. In addition, the 3D map is not always in the second 3D map display state and is in the first 3D map display state before the satisfaction of the switching condition. In the first 3D map display state, an impression of a wide area containing multiple buildings can be checked against the scenery in his or her memory or the scenery that a person is actually seeing.

Embodiments of the present invention are not limited to the above embodiments, and can be modified in various ways, examples of which will be described below.

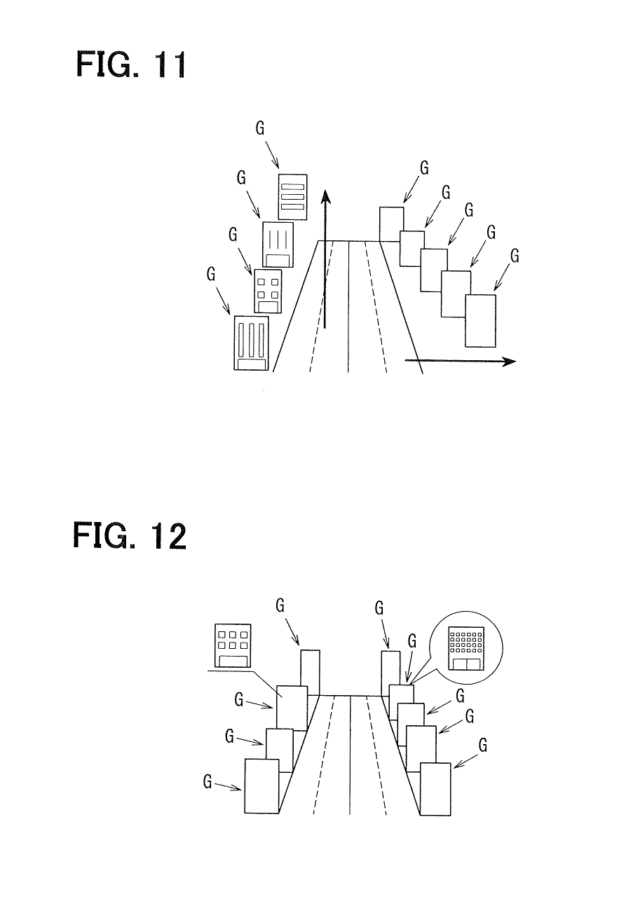

In the above embodiment, the navi. ECU 50 performs the first and second rotation displacement operations on the front view building images G. Alternatively, the navi. ECU 50 may not perform the rotation displacement operations on the front view building images G and may displace the front view building images G in an upper/lower direction or a left/right direction so that the displaced front view building images G are less overlapped with other front view building images G hidden by the displaced front view building images G. In FIG. 11, the front view building images G arranged on a left side of the road are examples of ones displaced in the upper direction. In FIG. 11, the front view building images G arranged on a right side of the road are examples of ones displaced in a right direction (a direction away from the road). It should be noted that the front view building images G may be displaced in both of the upper/lower direction and the left/right direction.

In the above embodiment, the navi. ECU 50 performs, as a sequential operation, the sequential motion operation including moving the front view building images G. As shown in FIG. 12, in place of moving, the navi. ECU 50 may display in turn copies of the front view building images G in association with the positions of the original front view building images G as the present position of the vehicle moves, so that one front view building image G on the right side of the road and another front view building image G on the right side of the road determined in relation to the position of the viewpoint are selected as targets.

In the above embodiments, in the second 3D map display state, the navi. ECU 50 performs the sequential operation without determining an overlap between the front view building images displayed on a viewpoint side and other front view building image displayed more distant. Alternatively, the navi. ECU may determine the overlap, and may perform the sequential operation only when there is the overlap.

In place of the above-described sequential motion operation, the navi. ECU 50 may not move but downsize, as the sequential operation, the front view building images G closer to the viewpoint in the movement direction of the viewpoint, so that confirmation of that other distant front view building images G is facilitated. The navi. ECU 50 may enlarge a front view building image G so that confirmation of the front view building image G is facilitated. The navi. ECU 50 may perform both of downsizing and enlarging.

In the above embodiment, at a first stage of the second 3D may display state, all of the front view building images G within the action range are rotated to the position of being perpendicular to the line of sight. Alternatively, the front view building images G may be rotated to the position of being perpendicular to the line of sight one by one in order of increasing distance from the viewpoint.

In the above embodiment, the in-vehicle navigation apparatus 1 functions as a map display apparatus. The map display apparatus according to embodiments are not limited to one mounted to a vehicle, and may be a navigation device for a portable terminal. Alternatively, the map display apparatus may be one that does not function as a navigation apparatus.

In the above embodiment, the buildings TT on the near side of the intersecting road is rotated in the direction of the arrow in FIG. 9, thereby facilitating conformation of the front view building images G of the buildings TO located on the far side of the intersecting road. Alternatively, the buildings TT on the near side of the intersecting road may be temporality semi-transparent or transparent to facilitate confirmation of the front view building images G of the buildings TO located on the far side of the intersecting road.

In the above embodiments, when the instructions for far side building check is given, the navi. ECU 50 performs the first artifice and the second artifice. Alternatively, the navi. ECU 50 may perform the first artifice or the second artifice. In the above embodiment, giving the instructions for far side building check to the navigation apparatus 1 is a condition (also called a preset condition) for changing from the display manner (A) in FIG. 8 to the display manner (C) in FIG. 8. Alternatively, the predetermined condition may be that the viewpoint for map drawing or the present position, which is associated with the viewpoint, becomes located within a predetermine distance from an intersection. In the above embodiment, the viewpoint is set just above the vehicle. Alternatively, the position of the viewpoint may be changed into various positions such as a position above the vehicle at a predetermined backward angle, the position of the driver's eyes off the vehicle, and the like.

According to an example of the present disclosure, a map display apparatus configured in the following way can be provided. The map display apparatus includes: a display device that displays a 3D map on a map display screen; and a controller that causes the display device to display the 3D map in a first 3D map display state or a second 3D map display state, and switches a display state of the 3D map from the first 3D map display state to the second 3D map display state in response to satisfaction of a predetermined switching condition in the first 3D map display state. In the first 3D map display state, a road is drawn in an upper/lower direction of the map display screen and front view object images, each of which is an image of an object facing onto the road and viewed from the road, are arranged facing onto the road. In the second 3D map display state, at least some of the front view object images is rotated more toward position of being perpendicular to a line of sight than in the first 3D map display state.

According to the above configuration, in response to the satisfaction of the predetermined switching condition, the front view object images are switched from the first 3D map display state to the second 3D map display state. In the first 3D map display state, the front view object images are arranged facing onto the road drawn in the vertical direction of the map display screen and the front view object images are accordingly inclined with respect to the line of sight. In the second 3D map display state, at least some of the front view object images is rotated more toward the position of being perpendicular to the line of sight than in the 3D map display state. Therefore, the front view object images of individual objects becomes easily conformable as compared to a conventional 3D map in which front view object images are arranged always facing onto a road. In actual scenery, front faces of objects are often visible, and further, impressions of the front faces of objects are often memorable. Thus, when the front view object images of individual objects are easily confirmable in a manner like that in the present invention, a front view object image displayed on the map display screen can be easily checked against an object in one's memory or a building that a person is actually seeing.

The above map display apparatus may be configured in the following way.

In the second 3D map display state, the controller performs a sequential operation such that as a viewpoint for map drawing moves along the road on which the front view object images are arranged, the controller makes a change in drawing state of the front view object images into another drawing state in order of increasing distance from the viewpoint along a movement direction of the viewpoint, so that one of the front view object images, the one having been changed into the another drawing state, become less overlapped with the others of front view object images.

According to the above configuration, as the viewpoint for map drawing moves along the road, front view object images are hidden by other front view object images to a smaller extent in the order of increasing distance from the viewpoint.

Therefore, as the viewpoint moves, the multiple front view object images drawn in the movement direction of the viewpoint become well confirmable in the order with a small overlap of the front view object images.

The above map display apparatus may be configured in the following way. The map display apparatus is mounted to a vehicle. A viewpoint for map drawing is set based on position of the vehicle and moves with movement of the vehicle. In this case, the controller performs a sequential process such that as the vehicle moves, the controller moves the front view object images in an order of increasing distance from the viewpoint along a movement direction of the viewpoint, so that one of the front view object images, one having been moved, becomes less overlapped with the others of front view object images.

The above map display apparatus may be configured in the following way. In the sequential operation, the controller moves in turn the front view object images in such a direction that ones of the front view object images become less overlapped with the others of the front view object images. The ones are located closer to the viewpoint. and the others are located distant from the viewpoint than the ones are.

When the front view object images are moved as described above, there are multiple modes. In one mode, the front view object images may be rotated and displaced. In another mode, the front view object images are displaced in an upper, lower, left or right direction.

To rotate and displace the front view object images, the controller may perform the following process for example. in the sequential operation, the controller rotates and displaces the front view object images by rotating each front view object image around a rotation axis by using a lower side of the each front view object image as the rotation axis to make an upper side of the each front view object image fall toward an outside of the road, while rotating and displacing the each front view object image into position where the lower side of the each front view object image contacts the road onto which the each front view object image in the first 3D map display state faces. When rotating and displacing are performed in the above way, a drawing target region does not extend toward the outside of the road. Thus, with a small drawing target region, it is possible to prevent the front view object images from overlapping each other. When the front view object images are displaced in an upper, lower, left or right direction, there are multiple modes. In one mode, the direction of movement of the front view object images in the sequential operation may be at least one of the vertical direction and a horizontal direction.

In rotating and displacing through making the upper side fall toward the outside of the road by using the lower side as the rotation axis, the controller may suppresses rotation and displacement of a specific one of the front view object images in the sequential operation, the specific one being an image of a preset mark object, until the viewpoint for map drawing passes through the preset mark object. In the above way, a period of time for recognition of the front view object image of the mark object becomes longer than a period of time for recognition of the front view objects of other objects. Therefore, checking of the mark object is facilitated in particular. The mark object in the traveling may be, for example, an object that is located around and before an intersection with respect to a traveling direction, another object that indicates a destination (including a destination on the way, i.e., a stop-off point), or the like.

The change in drawing state in the sequential operation may not be limited to movement. For example, the change in drawing state in the sequential operation is at least one of; size reduction of one or ones of the front view object images, the one or ones being located closer to the viewpoint in the movement direction of the viewpoint than the others of the front view object images are; and size enlargement of the others of the front view object images, the others being located distant from the viewpoint in the movement direction of the viewpoint than the one or ones of the front view object images is.

The above map display apparatus may be configured in the following way. In response to the satisfaction of the predetermined switching, the controller simultaneously rotates and displaces the front view object images, which exist forward of the viewpoint in the movement direction of the viewpoint, to the position of being perpendicular to the line of sight, and then, the controller performs the sequential process in the second 3D map display state. According to the above way, first, it becomes possible to simultaneously confirm the front view object images, which exist forward of the viewpoint in the movement direction of the viewpoint. And then, since the sequential process is performed, it becomes possible to confirm individual front view object images in the order because of the sequential process.

The above map display apparatus may be configured in the following way. In the 3D map, each object facing onto the road is drawn as a flat plate, and each front view object image appears on the flat plate. In the first 3D map display state, a surface of the flat plate, the surface on which the each front view object image appears, faces onto the road. According to the above way, even when the multiple front view object images are drawn in the map display screen, it is possible to suppress the overlap of front view object images with each other.

The above map display apparatus may be configured in the following way.

An object mirror image, which is a mirror image of the front view object image, appears on a surface of each of flat plates that are arranged along and on a viewpoint side of another road intersecting with the movement direction of the viewpoint, such that the object mirror image appears on the surface on an opposite side of the each of the flat plates from the another road. According to the above way, since the object mirror images is displayed, it becomes possible to check the impression of front faces of objects even when the front faces (faces viewed from a road side) of the objects are not visible from the viewpoint of the 3D map.

The above map display apparatus may be configured in the following way. A portion of the 3D map separated from the road by the object facing onto the road is displayed in single color. According to the above way, since the front view object images become well visible, it becomes possible to easily catch shape and height etc. of the front faces of the objects from the front view object images

The above map display apparatus may be configured in the following way when at least part of a certain front view object image, the certain front view image being facing onto another road intersecting with the movement direction of the viewpoint, is hidden by another front view object image that is between the viewpoint and the certain front view object image, the controller makes a change in drawing state of one of the hidden certain front view object image or the hiding another front view object image in response to satisfaction of a preset condition so that the hidden certain front view object image becomes viewable.

According to the above map display apparatus, even when the front view object images facing onto the another road intersecting with the road along which the viewpoint moves are hidden by other front view object images located closer the viewpoint than the front view object images, the hidden front view object images can be easily checked.

A manner of making the hidden front view object images more visible may be, for example, the followings. The controller displaces the hidden certain front view object image in the upper direction, and in accordance with upward displacement, the controller inclines the another road, onto which the hidden certain front view object image faces, so that a portion of the another road, which is closer to the hidden certain front view object than the other portion of the another road is, is displaced in the upper direction. Alternatively, by using a lower side of the hidden certain front view object image as a rotation axis, the controller rotates and displaces the hidden certain front view object image so that an upper side of the hidden certain front view object image moves away from the hiding another front view object image.

An object facing onto a road and displayed as a front view object image include, for example, a building. That is, each front view object image may be a front view building image, which is a front view image of a building. Alternatively, in place of the front view building image or in addition to the front view building image, a front view image of an advertising display, a tree or the like may be displayed.

Embodiments, configurations and aspects etc. related to the present invention are not limited to respective embodiments, configurations and aspects etc. described above. Embodiments, configurations and aspects etc. that are obtained by appropriately combining technical portions disclosed in different embodiments, configurations and aspects etc. are covered by embodiments, configurations and aspects etc. related to the present invention.

What is claimed is:

1. A map display apparatus comprising:
a display device that displays a 3D map on a map display screen; and
a controller that causes the display device to display the 3D map in a first 3D map display state or a second 3D map display state, and switches a display state of the 3D map from the first 3D map display state to the second 3D map display state in response to satisfaction of a predetermined switching condition in the first 3D map display state,
wherein:
in the first 3D map display state,
a road is drawn in an upper/lower direction of the map display screen and
front view object images, each of which is an image of an object facing onto the road and viewed from the road, are arranged facing onto the road; and
in the second 3D map display state,
at least some of the front view object images is rotated more toward position of being perpendicular to a line of sight than in the first 3D map display state.

2. The map display apparatus according to claim 1, wherein:
In the second 3D map display state, the controller performs a sequential operation such that
as a viewpoint for map drawing moves along the road on which the front view object images are arranged, the controller makes a change in drawing state of the front view object images into another drawing state in order of increasing distance from the viewpoint along a movement direction of the viewpoint, so that one of the front view object images, the one having been changed into the another drawing state, become less overlapped with the others of front view object images.

3. The map display apparatus according to claim 1, wherein:
the map display apparatus is mounted to a vehicle;
a viewpoint for map drawing is set based on position of the vehicle and moves with movement of the vehicle; and
the controller performs a sequential process such that as the vehicle moves, the controller moves the front view object images in an order of increasing distance from the viewpoint along a movement direction of the viewpoint, so that one of the front view object images, one having been moved, becomes less overlapped with the others of front view object images.

4. The map display apparatus according to claim 2, wherein:
in the sequential operation, the controller moves in turn the front view object images in such a direction that ones of the front view object images become less overlapped with the others of the front view object images;
the ones are located closer to the viewpoint; and
the others are located distant from the viewpoint than the ones are.

5. The map display apparatus according to claim 4, wherein:
in the sequential operation, the controller rotates and displaces the front view object images by
rotating each front view object image around a rotation axis by using a lower side of the each front view object image as the rotation axis to make an upper side of the each front view object image fall toward an outside of the road
while rotating and displacing the each front view object image into position where the lower side of the each front view object image contacts the road onto which the each front view object image in the first 3D map display state faces.

6. The map display apparatus according to claim 4, wherein:
the direction of movement of the front view object images in the sequential operation is at least one of the vertical direction and a horizontal direction.

7. The map display apparatus according to claim 5, wherein:
In the sequential operation, the controller suppresses rotation and displacement of a specific one of the front view object images, the specific one being an image of a preset mark object, until the viewpoint for map drawing passes through the preset mark object; and
the rotation and the displacement include making the upper side fall toward the outside of the road by using the lower side as the rotation axis.

8. The map display apparatus according to claim 2, wherein:
the change in drawing state in the sequential operation is at least one of
size reduction of one or ones of the front view object images, the one or ones being located closer to the viewpoint in the movement direction of the viewpoint than the others of the front view object images is, and
size enlargement of the others of the front view object images, the others being located distant from the viewpoint in the movement direction of the viewpoint than the one or ones of the front view object images is.

9. The map display apparatus according to claim 2, wherein:
in response to the satisfaction of the predetermined switching, the controller simultaneously rotates and displaces the front view object images, which exist forward of the viewpoint in the movement direction of the viewpoint, to the position of being perpendicular to the line of sight, and then the controller performs the sequential process in the second 3D map display state.

10. The map display apparatus according to claim 1, wherein:
in the 3D map, each object facing onto the road is drawn as a flat plate , and each front view object image appears on the flat plate; and
in the first 3D map display state, a surface of the flat plate, the surface on which the each front view object image appears, faces onto the road.

11. The map display apparatus according to claim 10, wherein:
an object mirror image, which is a mirror image of the front view object image, appears on a surface of each of flat plates that are arranged along and on a viewpoint side of another road intersecting with the movement direction of the viewpoint, such that the object mirror image appears on the surface on an opposite side of the each of the flat plates from the another road.

12. The map display apparatus according to claim 1, wherein:
a portion of the 3D map separated from the road by the object facing onto the road is displayed in single color.

13. The map display apparatus according to claim 1, wherein:
when at least part of a certain front view object image that faces onto another road intersecting with the movement direction of the viewpoint, is hidden by another front view object image that is between the viewpoint and the certain front view object image,
the controller makes a change in drawing state of one of the hidden certain front view object image or the hiding another front view object image in response to satisfaction of a preset condition so that the hidden certain front view object image becomes viewable.

14. The map display apparatus according to claim 13, wherein:
the controller
displaces the hidden certain front view object image in the upper direction, and accordingly
inclines the another road, onto which the hidden certain front view object image faces,
so that a portion of the another road, which is closer to the hidden certain front view object image than the other portion of the another road is, is displaced in the upper direction.

15. The map display apparatus according to claim 13, wherein:
by using a lower side of the hidden certain front view object image as a rotation axis, the controller rotates and displaces the hidden certain front view object image so that an upper side of the hidden certain front view object image moves away from the hiding another front view object image.

16. The map display apparatus according to claim 1, wherein:
each front view object image is a front view building image, which is an front view image of a building.
